(19) United States
(12) Patent Application Publication
(10) Pub. No.: US 2012/0145201 A1
(43) Pub. Date: Jun. 14, 2012

(54) SPIN RINSE DRY APPARATUS AND METHOD OF PROCESSING A WAFER USING THE SAME

(76) Inventors: Chang-Hsin Wu, Hsinchu County (TW); Chih-Chao Tai, Hsinchu City (TW); Shieh-Chieh Chen, Tainan City (TW); I-Ting Huang, Hsinchu City (TW)

(21) Appl. No.: 12/966,988

(22) Filed: Dec. 13, 2010

(51) Int. Cl. B08B 3/00

(52) U.S. Cl. 134/28; 134/198

(57) ABSTRACT

A spin-rinse-dry (SRD) apparatus includes a housing; a pedestal in the housing, comprising a rotatable wafer supporter for holding and spinning a semiconductor wafer; and at least a first liquid dispensing tube in adjacent to the pedestal. The first liquid dispensing tube includes a bended tubular part and an outlet nozzle that is situated beyond an edge of the semiconductor wafer.

### BACKGROUND OF THE INVENTION

1. Field of the Invention

The present invention relates generally to an apparatus for processing semiconductor wafers. More particularly, the present invention relates to an improved spin-rinse-dry (SRD) apparatus of an electrochemical plating (ECP) system and a method of processing a wafer by utilizing the improved SRD apparatus.

2. Description of the Prior Art

As device geometries continue to shrink, copper electroplating faces a number of challenges such as void-free filling of narrow and deep features, plating on thin seed layers, and reducing plating defects. Electrochemical plating (ECP) has emerged as promising processes for void free filling of sub-quarter micron sized high aspect ratio interconnect features in integrated circuit manufacturing processes.

In an ECP process, a seed layer is first formed over the surface features of the substrate, and then the surface features of the substrate are exposed to an electrolyte solution in a plating cell, while an electrical bias is applied between the seed layer and a copper anode positioned within the electrolyte solution. The electrolyte solution generally contains ions to be plated onto the surface of the substrate, and therefore, the application of the electrical bias causes these ions to be plated onto the biased seed layer, thus depositing a layer of the ions on the substrate surface that may fill the features.

Once the plating process is completed, the substrate is generally transferred to a substrate rinsing cell or a bevel clean cell. Bevel edge clean is generally performed to remove unwanted metal from the perimeter or bevel of the substrate by dispensing an etchant thereon. The substrate rinse or spin rinse dry (SRD) process is generally operated to rinse the surface of the substrate with a rinsing solution to remove any contaminants. The substrate is often rotated at a high rate of speed in order to spin off any remaining fluid droplets adhering to the substrate surface. Once the remaining fluid droplets are spun off, the substrate is generally clean and dry, and therefore, ready for transfer from the ECP tool. Thereafter, the cleaned substrate may be transferred to an annealing chamber where the substrate is heated to a temperature sufficient to anneal the deposited film.

FIG. 1 shows diagrammatically a partial portion of a conventional SRD cell apparatus. As shown in FIG. 1, a substrate or wafer 1 is held by a wafer supporter 2, which is rotatable about a central axis 10 of the wafer 1. At least two fixed liquid dispensing tubes 3a and 3b are juxtaposed in proximity to the edge of the wafer 1. By way of example, the liquid dispensing tube 3a is typically used to deliver pure water, which is also referred to as “water tube”, while the liquid dispensing tube 3b is typically used to deliver acid solution such as sulfuric acid solution, which is also referred to as “acid tube”. The two liquid dispensing tubes 3a and 3b have bended tubular parts 31a and 31b respectively, which hang down directly over the wafer 1. The angle θ1 between the jet of liquid from the outlet nozzle 32a or 32b and the vertical line 40 is designed to precisely spread jet of liquid onto the center 10′ of the wafer 1. Conventionally, the wafer 1 is rotated directly under the outlet nozzle 32a or 32b.

However, the above-described conventional art has shortcomings. For example, after the final rinse step is completed, defects are often observed in the area 12 on an active side 1a of the wafer 1. These defects stem from the acid drips 42 falling from the outlet nozzle 32a or 32b situated directly over the area 12 or condensed acid mist 52 dripping from the lower surface of the bended tubular part 31a or 31b. Therefore, there is a need in this industry to provide an improved apparatus for processing wafers, which is capable of avoiding the prior art problems and shortcomings.

### SUMMARY OF THE INVENTION

It is one object of the invention to provide an improved SRD apparatus for processing wafers, which is capable of avoiding the problem of acid drips.

According to one aspect of the invention, a spin-rinse-dry (SRD) apparatus is provided. The SRD apparatus includes a housing; a pedestal in the housing, comprising a rotatable wafer supporter for holding and spinning a semiconductor wafer; and at least a first liquid dispensing tube in adjacent to the pedestal, the first liquid dispensing tube comprising a bended tubular part and an outlet nozzle that is situated beyond an edge of the semiconductor wafer.

According to another aspect of the invention, a method of processing a wafer is provided. The method is carried within a spin-rinse-dry (SRD) apparatus comprising a housing; a pedestal in the housing, comprising a rotatable wafer supporter for holding and spinning a semiconductor wafer; and at least a first liquid dispensing tube in adjacent to the pedestal, wherein the first liquid dispensing tube comprises a bended tubular part and an outlet nozzle that is situated beyond an edge of the semiconductor wafer. The method comprises the following steps: (1) subjecting the semiconductor wafer to a first pure water rinse; (2) subjecting the semiconductor wafer to a bevel edge clean; (3) subjecting the semiconductor wafer to a second pure water rinse; and (4) subjecting the semiconductor wafer to H₂SO₄ rinse by applying H₂SO₄ solution to the semiconductor wafer via the first liquid dispensing tube.

According to another aspect of the invention, a method of processing a wafer is provided. The method is carried within a spin-rinse-dry (SRD) apparatus comprising a housing; a pedestal in said housing, comprising a rotatable wafer supporter for holding and spinning a semiconductor wafer; and at least a first liquid dispensing tube in adjacent to said pedestal, wherein said first liquid dispensing tube comprises a bended tubular part and an outlet nozzle that is situated beyond an edge of said semiconductor wafer. The method comprises the following steps: (1) supplying liquid onto said semiconductor wafer; and (2) spinning said semiconductor wafer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a schematic, partial view of a conventional SRD cell apparatus.

FIG. 2 is a schematic, cross-sectional diagram showing an SRD apparatus in accordance with one preferred embodiment of this invention; and

FIG. 3 is a flow diagram showing an exemplary SRD process 500 in accordance with one embodiment of the invention.

It should be noted that all the figures are diagrammatic. Relative dimensions and proportions of parts of the drawings have been shown exaggerated or reduced in size, for the sake of clarity and convenience in the drawings. The same reference signs are generally used to refer to corresponding or similar features in modified and different embodiments.

### DETAILED DESCRIPTION

In the following description, numerous specific details are given to provide a thorough understanding of the invention. However, it will be apparent to one skilled in the art that the invention may be practiced without these specific details. In order to avoid obscuring the present invention, some well-known system configurations and process steps are not disclosed in detail.

Likewise, the drawings showing embodiments of the apparatus are semi-diagrammatic and not to scale and, particularly, some of the dimensions are for the clarity of presentation and are shown exaggerated in the FIGS. Also, where multiple embodiments are disclosed and described having some features in common, for clarity and ease of illustration and description thereof like or similar features one to another will ordinarily be described with like reference numerals.

The term “horizontal” as used herein is defined as a plane parallel to the conventional major plane or surface of the semiconductor substrate or wafer, regardless of its orientation. The term “vertical” refers to a direction perpendicular to the horizontal as just defined. Terms, such as “on”, “side” (as in “sidewall”), “higher”, “lower”, “over”, and “under”, may be defined with respect to the horizontal plane.

The present invention pertains to an apparatus for processing a semiconductor work piece such as a semiconductor substrate or wafer. More specifically, the embodiments of present invention provides an improved spin-rinse-dry (SRD) apparatus that is capable of preventing the problem of acid dripping onto the wafer, thereby improving reliability and yield of manufacture. It is to be understood that the SRD apparatus may be a SRD cell that is integrally embedded in an ECP tool. Typically, the ECP tool may contain a load/unload port, an anneal chamber, a plating and rinse chamber, and robot for transferring the wafer. The SRD cell may be provided in the plating and rinse chamber. However, it is to be understood that the present invention may be applicable in other technical fields other than the SRD apparatus or the ECP tools.

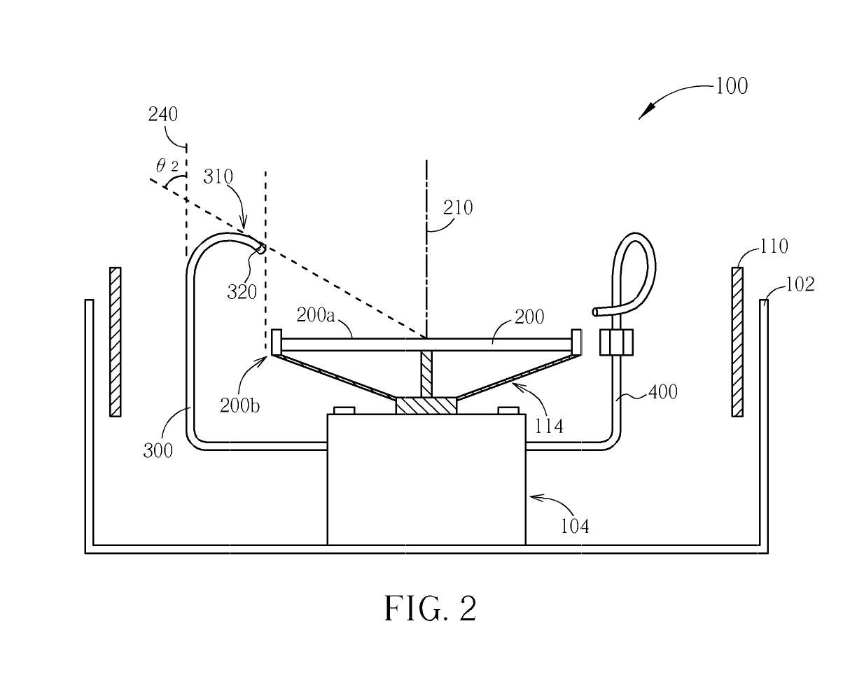

FIG. 2 is a schematic, cross-sectional diagram showing an SRD apparatus in accordance with one preferred embodiment of this invention. As shown in FIG. 2, the SRD apparatus 100 generally comprises a cell housing 102, a pedestal 104 disposed in the cell housing 102 and comprising a wafer supporter 114 for firmly holding and rotating a semiconductor wafer 200, and at least one fixed liquid dispensing tube 300 protruding from a sidewall of the pedestal 104 and extending vertically in an upright position straight. The SRD apparatus 100 may further comprise a retractable hood 110, which arises from a lower position to a higher position to stop spattered liquid drops falling from the surface of the semiconductor wafer 200. The SRD apparatus 100 may further comprise a rotatable liquid dispensing tube 400 for delivering etchant such as mixed strong acid solution containing hydrogen peroxide and sulfuric acid (H₂O₂/H₂SO₄) in a bevel edge clean step, which is performed to remove unwanted metal from the perimeter or bevel of the wafer by dispensing an etchant thereon.

According to the embodiment, the upper end of the fixed liquid dispensing tube 300 is a downward bended tubular part 310 with an outlet nozzle 320 directed toward the horizontal active surface 200a of the semiconductor wafer 200. According to the embodiment of the invention, the fixed liquid dispensing tube 300 may be an “acid tube” or a “water tube”. Although not shown in this figure, it is to be understood that SRD apparatus 100 may comprises a plurality of fixed liquid dispensing tube 300, which are juxtaposed in proximity to the edge 200b of the semiconductor wafer 200.

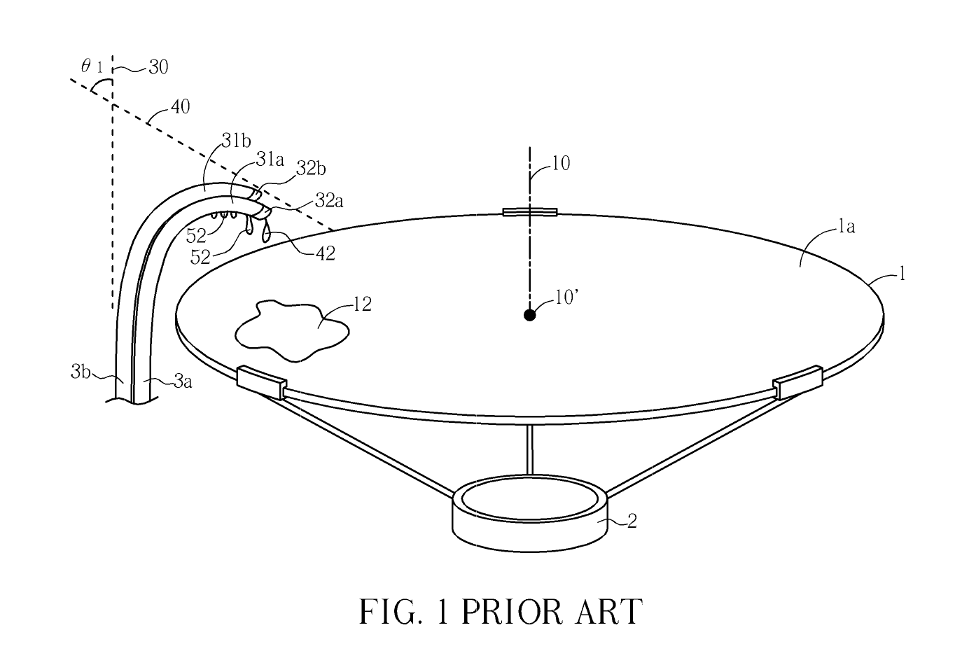

It is one technical feature of this embodiment of the invention that the bended tubular part 310 of the fixed liquid dispensing tube 300 is shortened such that the outlet nozzle 320 is situated beyond the edge 200b of the semiconductor wafer 200. By providing such configuration, the acid residual either within the bended tubular part 310 or on the lower surface of the bended tubular part 310 does not drip onto the active surface 200a of the semiconductor wafer 200. Instead, the acid residual drips inside the cell housing 102 and may be recovered via a drain system (not shown). To ensure that the jet of liquid can be precisely spread onto the center of the semiconductor wafer 200, the angle θ2 between the jet of liquid from the outlet nozzle 320 and the vertical line 240 is larger than the angle θ1 in FIG. 1. For example, the angle θ2 may range between 60 degrees and 80 degrees.

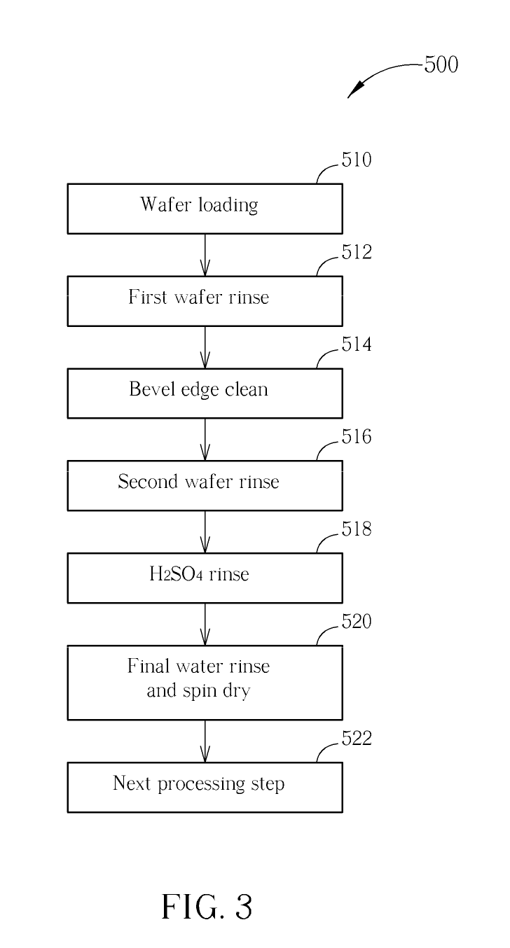

Please refer to FIG. 3, and briefly to FIG. 2, wherein FIG. 3 is a flow diagram showing an exemplary SRD process 500 in accordance with one embodiment of the invention. The exemplary SRD process 500 is carried out in the SRD apparatus 100 in FIG. 2. As shown in FIG. 3, in Step 510, the semiconductor wafer 200 (FIG. 2) having thereon a plated copper metal layer is loaded onto the pedestal 104 of the SRD apparatus 100 (FIG. 2). The semiconductor wafer 200 is held by the wafer supporter 114 and spins at a given speed of rotation. In Step 512, pure water is applied to the semiconductor wafer 200 via a “water tube” for removing residual CuSO₄ from the active surface 200a of the semiconductor wafer 200. In Step 514, a bevel edge clean step is carried out. A mixed strong acid solution such as hydrogen peroxide and sulfuric acid (H₂O₂/H₂SO₄) solution is applied to the semiconductor wafer 200 to remove unwanted metal from the perimeter or bevel of the semiconductor wafer 200. In Step 516, after the bevel edge clean step, pure water is applied to the semiconductor wafer 200 to clean the surface of the semiconductor wafer 200. In Step 518, a 1-2 second H₂SO₄ rinse step is carried out to remove copper oxide. In Step 520, pure water is again applied to the semiconductor wafer 200 to clean the surface of the semiconductor wafer 200 and water is spun off to provide a dry and clean wafer. In Step 522, the semiconductor wafer 200 is transferred and is subjected to the next processing step such as anneal or chemical mechanical polishing (CMP).

Those skilled in the art will readily observe that numerous modifications and alterations of the device and method may be made while retaining the teachings of the invention.

What is claimed is:

1. A spin-rinse-dry (SRD) apparatus, comprising:
a housing;
a pedestal in said housing, comprising a rotatable wafer supporter for holding and spinning a semiconductor wafer; and
at least a first liquid dispensing tube in adjacent to said pedestal, said first liquid dispensing tube comprising a bended tubular part and an outlet nozzle that is situated beyond an edge of said semiconductor wafer.

2. The SRD apparatus according to claim 1 wherein pure water is applied to said semiconductor wafer via said first liquid dispensing tube.

3. The SRD apparatus according to claim 1 wherein sulfuric acid (H₂SO₄) solution is applied to said semiconductor wafer via said first liquid dispensing tube.

4. The SRD apparatus according to claim 1 further comprising a second liquid dispensing tube installed in adjacent to said pedestal.

5. The SRD apparatus according to claim 4 wherein hydrogen peroxide and sulfuric acid (H₂O₂/H₂SO₄) solution is applied to said semiconductor wafer via said second liquid dispensing tube.

6. The SRD apparatus according to claim 1 wherein said first liquid dispensing tube is a fixed liquid dispensing tube.

7. The SRD apparatus according to claim 1 wherein said first liquid dispensing tube protrudes from a sidewall of said pedestal and extends vertically in an upright position straight.

8. The SRD apparatus according to claim 1 wherein an angle between a jet of liquid from said outlet nozzle and a vertical line ranges between 60 degrees and 80 degrees.

9. The SRD apparatus according to claim 1 wherein said SRD apparatus is embedded in an electrochemical plating (ECP) tool.

10. A method of processing a wafer, wherein said method is carried within a spin-rinse-dry (SRD) apparatus comprising a housing; a pedestal in said housing, comprising a rotatable wafer supporter for holding and spinning a semiconductor wafer; and at least a first liquid dispensing tube in adjacent to said pedestal, wherein said first liquid dispensing tube comprises a bended tubular part and an outlet nozzle that is situated beyond an edge of said semiconductor wafer, said method comprises the following steps:
(1) subjecting said semiconductor wafer to a first pure water rinse;
(2) subjecting said semiconductor wafer to a bevel edge clean;
(3) subjecting said semiconductor wafer to a second pure water rinse; and
(4) subjecting said semiconductor wafer to H₂SO₄ rinse by applying H₂SO₄ solution to said semiconductor wafer via said first liquid dispensing tube.

11. The method of processing a wafer according to claim 10 wherein said first liquid dispensing tube protrudes from a sidewall of said pedestal and extends vertically in an upright position straight.

12. The method of processing a wafer according to claim 10 wherein an angle between a jet of liquid from said outlet nozzle and a vertical line ranges between 60 degrees and 80 degrees.

13. A method of processing a wafer, wherein said method is carried within a spin-rinse-dry (SRD) apparatus comprising a housing; a pedestal in said housing, comprising a rotatable wafer supporter for holding and spinning a semiconductor wafer; and at least a first liquid dispensing tube in adjacent to said pedestal, wherein said first liquid dispensing tube comprises a bended tubular part and an outlet nozzle that is situated beyond an edge of said semiconductor wafer, said method comprises the following steps:
(1) supplying liquid onto said semiconductor wafer; and
(2) spinning said semiconductor wafer.

14. The method of processing a wafer according to claim 13 wherein said first liquid dispensing tube protrudes from a sidewall of said pedestal and extends vertically in an upright position straight.

15. The method of processing a wafer according to claim 13 wherein an angle between a jet of liquid from said outlet nozzle and a vertical line ranges between 60 degrees and 80 degrees.
